(19) United States
(12) Patent Application Publication
(10) Pub. No.: US 2014/0253411 A1
(43) Pub. Date: Sep. 11, 2014

(54) WIRELESS TERMINAL

(71) Applicants: Lu Zhang, Shenzhen City (CN); Long Li, Shenzhen City (CN); Yang Yang, Shenzhen City (CN)

(72) Inventors: Lu Zhang, Shenzhen City (CN); Long Li, Shenzhen City (CN); Yang Yang, Shenzhen City (CN)

(73) Assignee: ZTE CORPORATION

(21) Appl. No.: 14/352,287

(22) PCT Filed: Feb. 20, 2012
(86) PCT No.: PCT/CN2012/071356

§ 371 Date: Apr. 16, 2014

(30) Foreign Application Priority Data
Oct. 18, 2011 (CN) 201120396693.2

(51) Int. Cl. H01Q 9/04

(52) U.S. Cl. CPC H01Q 9/0407
USPC 343/904

(57) ABSTRACT

Disclosed is a wireless terminal. The wireless terminal comprises: a printed circuit board (21), an antenna (22) coupled onto the printed circuit board (21) and configured to transmit electromagnetic waves, a parasitic unit (23) coupled onto the printed circuit board (21) and configured to lower an SAR peak value of the electromagnetic waves, and a lumped element (24) coupled onto the parasitic unit (23) and configured to adjust the amplitude and phase of the current in the parasitic unit (23). The disclosure lowers the SAR under the premise of not affecting the communication quality of the wireless terminal, thereby reducing production costs.

### TECHNICAL FIELD

The disclosure relates to the communication field, and in particular to a wireless terminal.

### BACKGROUND

With the rapid development of a wireless communication technology, a wireless terminal, such as a mobile terminal or a data card has been applied widely; moreover, the influence of the electromagnetic radiation from the wireless terminal on human body also becomes significant.

Recently, the index measuring the electromagnetic radiation from an antenna to a human body is called specific absorption rate (abbreviated as SAR). SAR is a measure of the electromagnetic wave energy from the wireless terminal absorbed by a human body, and the meaning thereof is “the electromagnetic wave power absorbed per time and per mass of tissue” and it has units of W/kg or mW/g. The Federal Communications Commission (abbreviated as FCC) clearly stipulates the allowed maximum SAR when various wireless terminals interact with a human body, and stipulates that the SAR of the mobile terminal should be measured when the mobile terminal is close to one side of the human brain, and that the SAR of the data card has to be measured on four surfaces near the data card. Therefore, it has become an important problem to be solved in the industry to lower the radiation to a human body effectively, ensuring the communication quality of the wireless terminal and miniaturized portability at the same time.

FIG. 1 is a schematic diagram of a basic structure of a terminal product belonging to a data card and of a measurement plane for SAR according to the relevant art, and as shown in FIG. 1, such a data-card-type terminal which generally uses a cubic chassis 11, and is connected to a notebook computer by a USB connector 12. Corresponding to such data card, the FCC stipulates that it is at least required to measure the SAR values for a human body from the four side planes of up, down, left and right, i.e. corresponding to directions of plane P1, plane P2, plane P3 and plane P4 in FIG. 1, and the measuring distance is 5 mm. In some special cases, it is also required to measure the SAR value of plane P5 at the top of the data card, which is considered in all cases where a human body is radiated when close to the data card in a daily use scenario.

The existing technology of lowering the SAR peak value of the wireless terminal is mostly done by coating a wave-absorbing material and/or radiation protection layer on the surface of the chassis of the wireless terminal, etc. While such a method has higher production costs, the wave-absorbing material and/or radiation protection layer will absorb useful signals which, as a result, affects the communication signal quality.

### SUMMARY

The disclosure provides a wireless terminal so as to at least solve the problem of high production costs and the communication quality being affected in the relevant art when lowering the SAR peak value of the wireless terminal using an absorbing material and/or radiation protection layer.

A wireless terminal provided by the disclosure comprises: a printed circuit board; an antenna coupled onto the printed circuit board and configured to transmit electromagnetic waves; a parasitic unit coupled onto the printed circuit board and configured to lower a SAR peak value of the electromagnetic waves; and a lumped element coupled onto the parasitic unit and configured to adjust an amplitude and phase of the current in the parasitic unit.

The lumped element is set on the parasitic unit.

The lumped element is coupled between the parasitic unit and the printed circuit board.

The lumped element comprises at least one of the following: a capacitor, an inductor and a resistor.

The length of the parasitic unit is a quarter of a working wavelength of the electromagnetic waves.

The shape of the parasitic unit is a single meander line.

The shape of the parasitic unit is symmetrical meander lines.

The material of the parasitic unit is metal.

The disclosure realizes near field coupling compensation between the antenna and the parasitic unit, weakens near field peak value, and ensures the working state of far field by means of adding the lumped element onto the parasitic unit which is coupled to the printed circuit board and is in the wireless terminal, adjusting the value of lumped element, and changing the amplitude and phase of the current in the parasitic unit. Therefore, the disclosure lowers the SAR under the premise of not affecting the communication signal quality of the wireless terminal, thereby reducing production costs.

### BRIEF DESCRIPTION OF THE DRAWINGS

The drawings, provided for further understanding of the disclosure and forming a part of the specification, are used to explain the disclosure together with embodiments of the disclosure rather than to limit the disclosure. In the drawings:

FIG. 1 is a schematic diagram of a basic structure of a terminal product belonging to a data card and of a measurement plane for SAR according to the relevant art;

FIG. 2 is a structural schematic diagram of a wireless terminal according to an embodiment of the disclosure;

FIG. 3 is a structural schematic diagram I of a wireless terminal according to a preferred embodiment of the disclosure;

FIG. 4 is a structural schematic diagram II of a wireless terminal according to a preferred embodiment of the disclosure;

FIG. 5 is a schematic diagram I of another form of a wire routing capable of being used by the parasitic unit according to an embodiment of the disclosure;

FIG. 6 is a schematic diagram II of another form of wire routing capable of being used by the parasitic unit according to an embodiment of the disclosure;

FIG. 7 is a schematic diagram III of another form of wire routing capable of being used by the parasitic unit according to an embodiment of the disclosure;

FIG. 8 is a schematic diagram IV of another form of wire routing capable of being used by the parasitic unit according to an embodiment of the disclosure;

FIG. 9 is a schematic diagram V of another form of wire routing capable of being used by the parasitic unit according to an embodiment of the disclosure;

FIG. 10 is a schematic diagram VI of another form of wire routing capable of being used by the parasitic unit according to an embodiment of the disclosure;

FIG. 11 is a schematic diagram of a changing curve of SAR peak values on planes P1-P4 when the loaded capacitance values for the lumped element are variable according to an embodiment of the disclosure;

FIG. 12 is a schematic diagram of a changing curve of SAR peak values on planes P1-P4 when the loaded inductance values for the lumped element are variable according to an embodiment of the disclosure; and

FIG. 13 is a schematic diagram of a changing curve of SAR peak values on planes P1-P4 when the loaded resistance values of the lumped element are variable according to an embodiment of the disclosure.

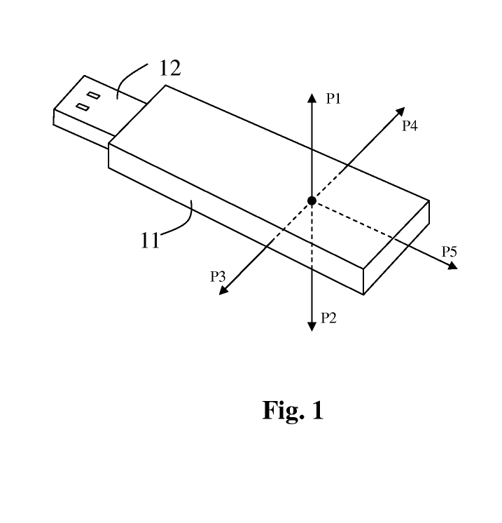

### DETAILED DESCRIPTION OF THE EMBODIMENTS

Note that, the embodiments of the disclosure and the features of the embodiments can be combined with each other if there is no conflict. The disclosure will be explained below with reference to the drawings and in conjunction with the embodiments in detail.

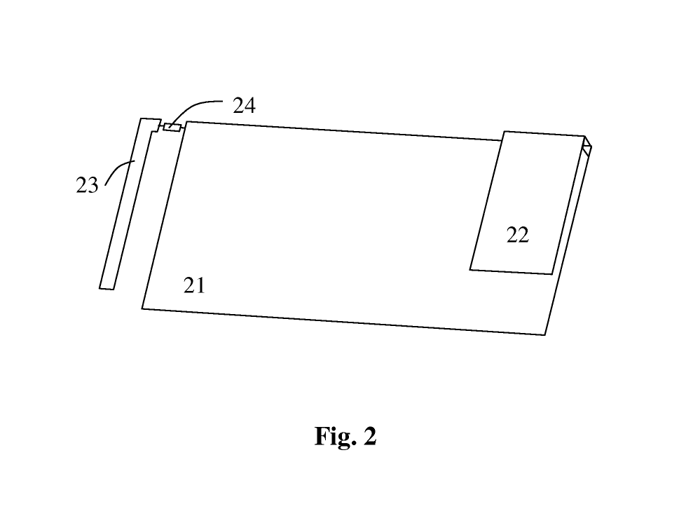

The disclosure provides a wireless terminal, and FIG. 2 is a structural schematic diagram of a wireless terminal according to an embodiment of the disclosure, and as shown in FIG. 2, the wireless terminal comprises: a printed circuit board 21, an antenna 22 coupled onto the printed circuit board 21 and configured to transmit electromagnetic waves, a parasitic unit 23 coupled onto the printed circuit board 21 and configured to lower an SAR peak value of the electromagnetic waves, and a lumped element 24 coupled onto the parasitic unit 23 and configured to adjust an amplitude and phase of an current in the parasitic unit 23.

In the relevant art, in order to lower the SAR peak value an absorbing material and/or radiation protection layer are used for the wireless terminal, and therefore, production costs are high and the communication quality is affected. In the embodiment of the disclosure, it realizes near field coupling compensation between the antenna 22 and the parasitic unit 23, weakens near field peak value, and ensures the working state of far field by means of adding the lumped element 24 onto the parasitic unit 23, which is coupled to the printed circuit board 21 and is in the wireless terminal, adjusting the value of lumped element, and changing the amplitude and phase of the electric current in the parasitic unit 23. Therefore, the disclosure lowers the SAR under the premise of not affecting the communication signal quality of the wireless terminal, thereby reducing production costs.

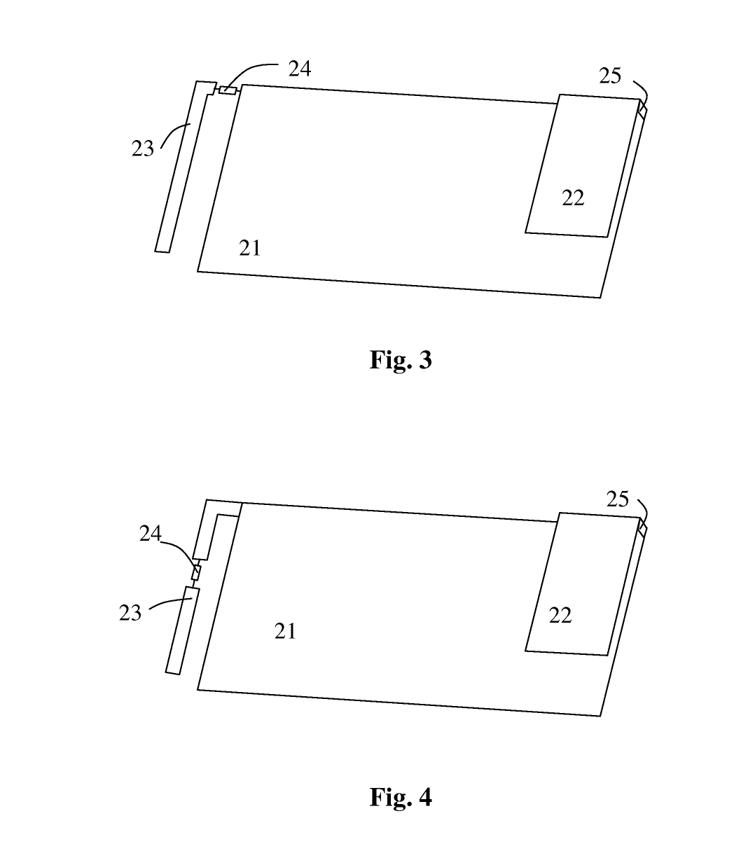

FIG. 3 is a structural schematic diagram I of a wireless terminal according to a preferred embodiment of the disclosure, and as shown in FIG. 3, the lumped element 24 may be set on the parasitic unit 23 so as to change the corresponding equivalent electrical length of the parasitic unit 23.

FIG. 4 is a structural schematic diagram II of a wireless terminal according to a preferred embodiment of the disclosure, and as shown in FIG. 4, the lumped element 24 may also be set at the other position of the parasitic unit 23, for example, being coupled between the parasitic unit 23 and the printed circuit board 21, thus further increasing design freedom.

It should be noted that the lumped element 24 may be implemented through a capacitor, an inductor and/or a resistor.

In addition, in the above-mentioned FIGS. 3 and 4, it further comprises an antenna feed 25 coupled between the antenna 22 and the printed circuit board 21.

The parasitic unit 23 will be described below in detail from the three aspects of length, shape and material respectively.
(1) The length of the parasitic unit 23 may be a quarter of a working wavelength of electromagnetic waves. The length of the parasitic unit 23 may be other values; however, the effect of lowering the SAR peak value is the best when the length of the parasitic unit 23 is taken as a quarter of the working wavelength of the electromagnetic waves.
(2) The shape of the parasitic unit 23 may be a single meander line or symmetrical meander lines.

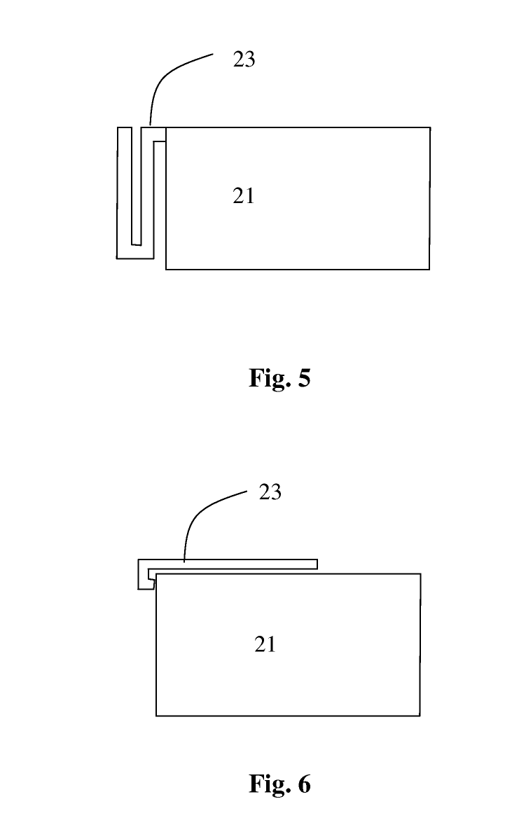

FIG. 5 is a schematic diagram I of another form of wire routing capable of being used by the parasitic unit according to an embodiment of the disclosure, and FIG. 6 is a schematic diagram II of another form of wire routing capable of being used by the parasitic unit according to an embodiment of the disclosure, and as shown in FIGS. 5 and 6, the parasitic unit 23 is located at one side of the printed circuit board 21 in the form of the single meander line. The parasitic unit 23 processed in the form of a meander line can save the structure space of the wireless terminal, which is beneficial to the miniaturization of the wireless terminal.

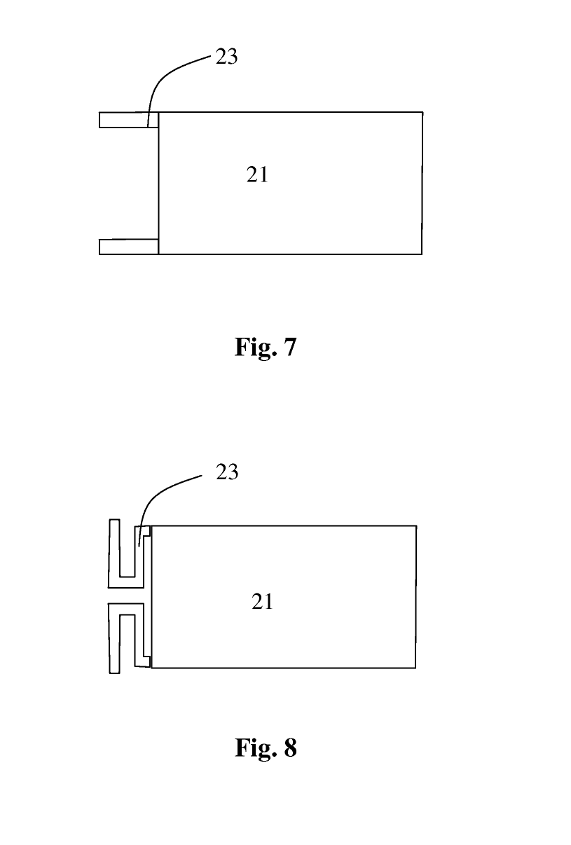

FIG. 7 is a schematic diagram III of another form of wire routing capable of being used by the parasitic unit according to an embodiment of the disclosure, and as shown in FIG. 7, the parasitic unit 23 is located at one side of the printed circuit board 21 and adopts the form of symmetrical straight lines.

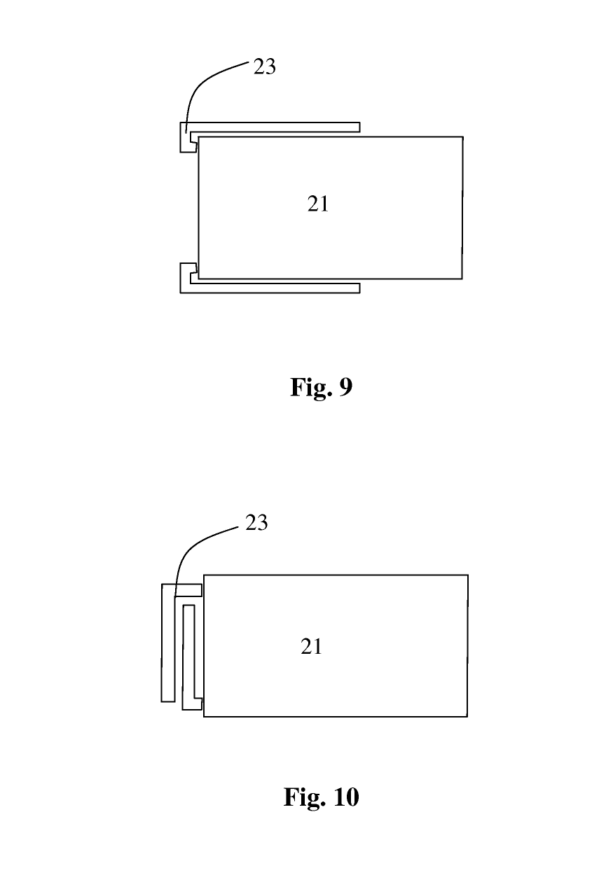

FIG. 8 is a schematic diagram IV of another form of wire routing capable of being used by the parasitic unit according to an embodiment of the disclosure, and FIG. 9 is a schematic diagram V of another form of wire routing capable of being used by the parasitic unit according to an embodiment of the disclosure, and as shown in FIGS. 8 and 9, the parasitic unit 23 is located at one side of the printed circuit board 21 in the form of the symmetrical meander lines. The parasitic unit 23 processed in the form of meander lines can save the structure space of the wireless terminal, which is beneficial to the miniaturization of the wireless terminal.

FIG. 10 is a schematic diagram VI of another form of wire routing capable of being used by the parasitic unit according to an embodiment of the disclosure, and as shown in FIG. 10, the parasitic unit 23 is located at one side of the printed circuit board 21 and adopts the form of similar meander lines so as to be symmetrical.
(3) The material of the parasitic unit 23 may be metal. The parasitic unit 23 made of commonly used metal may be etched on the printed circuit board 21 directly, thus reducing production costs.

On the basis of the above-mentioned wireless terminal, the disclosure further provides experiment parameters thereof so as to prove that it can lower the SAR under the premise of not affecting the communication signal quality of the wireless terminal. It will be described below in detail with reference to FIGS. 6a-6c.

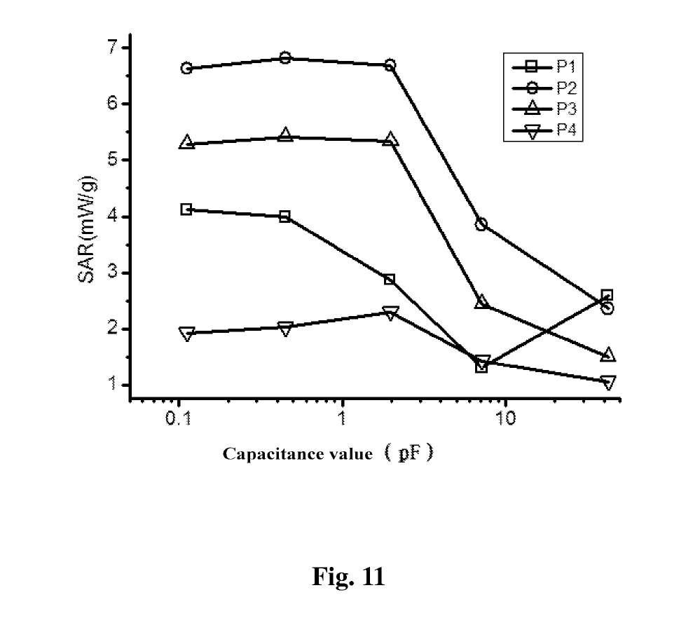

FIGS. 11-13 are curve diagrams of SAR peak values of a certain CDMA data card changing with a rated value of the lumped element on the parasitic unit according to an embodiment of the disclosure, as shown in figures, the lumped element 24 changes the SAR peak value through changing a rated parameter of the lumped element between the parasitic unit 23 and the printed circuit board 21. The data card works at the frequency band of CDMA 800 MHz (Cellular) and 1900 MHz (PCS), the size of the printed circuit board 21 is 23 mm×60 mm, and the antenna 22 is located at the top of the printed circuit board 21 in the form of monopole bracket antenna with a branch structure. The actual measurement and simulation of the data card indicate that the SAR peak value appears at the frequency band of 1900 MHz.

FIG. 11 is a schematic diagram of a changing curve of SAR peak values on planes P1-P4 when the loaded capacitance values for the lumped element are variable according to an embodiment of the disclosure, and the selection points corresponding to the capacitance values in the figure are: 0.112 pF, 0.4479 pF, 1.9717 pF, 7.1668 pF and 42.328 pF, and as shown in FIG. 6a, the SAR peak values on the four planes of measurement are all lower respectively when the capacitance value is 42.328 pF.

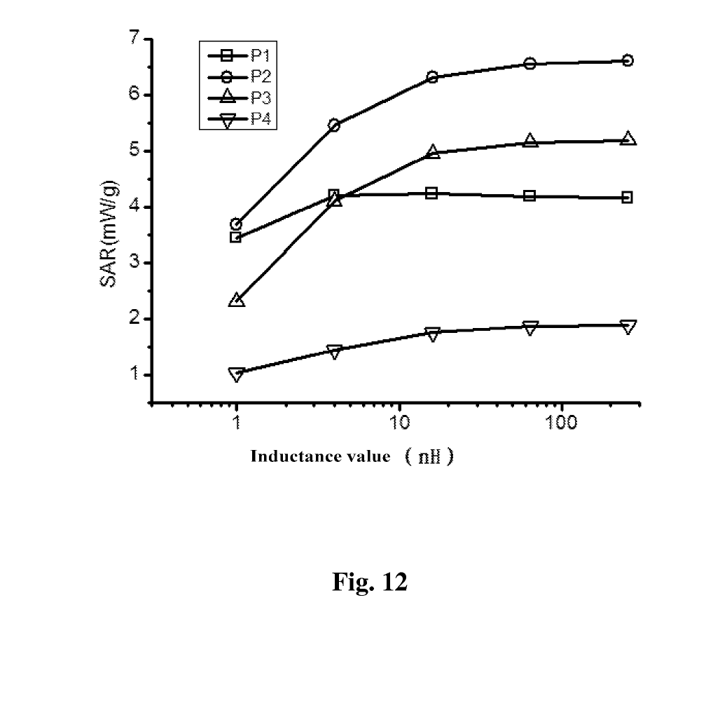

FIG. 12 is a schematic diagram of a changing curve of SAR peak values on planes P1-P4 when the loaded inductance values for the lumped element are variable according to an embodiment of the disclosure, the selection points corresponding to the inductance values in the figure are: 1 nH, 4 nH, 16 nH, 64 nH and 256 nH, and as shown in FIG. 6b, the SAR peak values on the four planes of measurement are all lower respectively when the inductance value is 1 nH.

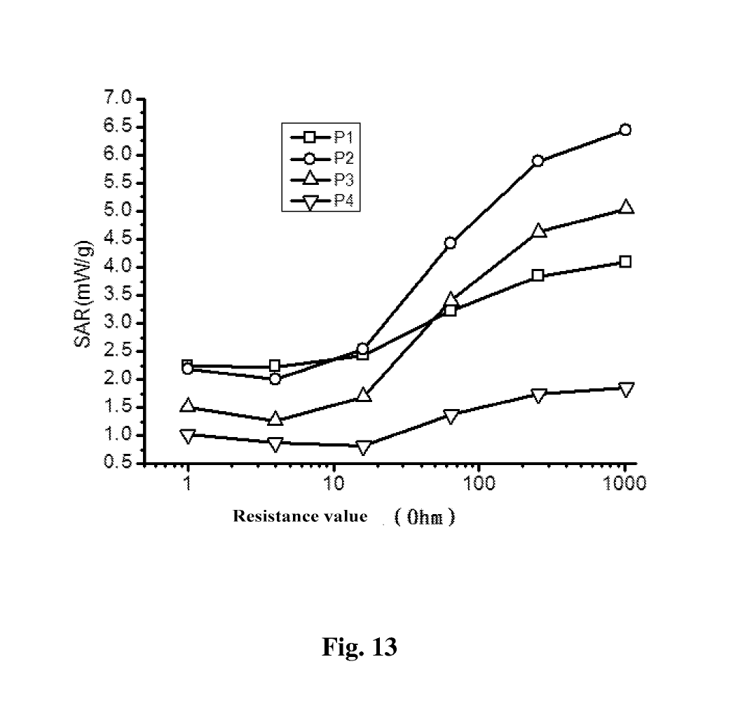

FIG. 13 is a schematic diagram of a changing curve of SAR peak values on planes P1-P4 when the loaded resistance values for the lumped element are various according to an embodiment of the disclosure, the selection points corresponding to the resistance values in the figure are: 1 Ohm, 4 Ohm, 16 Ohm, 64 Ohm, 256 Ohm and 1024 Ohm, and as shown in FIG. 6c, the SAR peak values on the four planes of measurement are all lower respectively when the resistance value is 4 Ohm.

It may be seen from the above three figures, setting suitable values for the capacitor, the inductor and the resistor coupled between the parasitic unit 23 and the printed circuit board 21 can all allow the SAR peak values on the four planes of measurement to be lowered respectively.

It should be noted that the disclosure is not merely restricted to a terminal product of a data card, but is also applicable to other terminal products such as mobile phones and tablet computers.

In conclusion, a wireless terminal is provided according to the above-mentioned embodiments of the disclosure. The disclosure realizes near field coupling compensation between the antenna 22 and the parasitic unit 23, weakens near field peak value, and ensures the working state of far field by means of adding the lumped element 24 onto the parasitic unit 23 coupled to the printed circuit board 21 coupled in the wireless terminal, adjusting the value of lumped element, and changing the amplitude and phase of the current in the parasitic unit 23. Therefore, the disclosure lowers the SAR under the premise of not affecting the communication quality of the wireless terminal, thereby reducing production costs.

Obviously, those skilled in the art shall understand that the above-mentioned modules or steps of the disclosure can be realized by using a general purpose calculating device, can be integrated in one calculating device or distributed on a network which consists of a plurality of calculating devices. Alternatively, the modules or the steps of the disclosure can be realized by using the executable program code of the calculating device. Consequently, they can be stored in the storing device and executed by the calculating device, or they are made into integrated circuit module respectively, or a plurality of modules or steps thereof are made into one integrated circuit module. In this way, the disclosure is not restricted to any particular hardware and software combination.

The descriptions above are only the preferable embodiment of the disclosure, which are not used to restrict the disclosure, and for those skilled in the art, the disclosure may have various changes and variations. Any modification, equivalent replacement, or improvement made within the spirit and principle of the disclosure shall all fall within the protection scope of the disclosure.

1. A wireless terminal, comprising:
a printed circuit board;
an antenna coupled onto the printed circuit board and configured to transmit electromagnetic waves;
a parasitic unit coupled onto the printed circuit board and configured to lower a Specific Absorption Rate (SAR) peak value of the electromagnetic waves; and
a lumped element coupled onto the parasitic unit and configured to adjust an amplitude and phase of the current in the parasitic unit.

2. The wireless terminal according to claim 1, wherein the lumped element is set on the parasitic unit.

3. The wireless terminal according to claim 1, wherein the lumped element is coupled between the parasitic unit and the printed circuit board.

4. The wireless terminal according to claim 1, wherein the lumped element comprises at least one of the following: a capacitor, an inductor and a resistor.

5. The wireless terminal according to claim 1, wherein a length of the parasitic unit is a quarter of a working wavelength of the electromagnetic waves.

6. The wireless terminal according to claim 1, wherein a shape of the parasitic unit is a single meander line.

7. The wireless terminal according to claim 1, wherein a shape of the parasitic unit is symmetrical meander line.

8. The wireless terminal according to claim 1, wherein a material of the parasitic unit is metal.

9. The wireless terminal according to claim 2, wherein a length of the parasitic unit is a quarter of a working wavelength of the electromagnetic waves.

10. The wireless terminal according to claim 3, wherein a length of the parasitic unit is a quarter of a working wavelength of the electromagnetic waves.

11. The wireless terminal according to claim 4, wherein a length of the parasitic unit is a quarter of a working wavelength of the electromagnetic waves.

12. The wireless terminal according to claim 2, wherein a shape of the parasitic unit is a single meander line.

13. The wireless terminal according to claim 3, wherein a shape of the parasitic unit is a single meander line.

14. The wireless terminal according to claim 4, wherein a shape of the parasitic unit is a single meander line.

15. The wireless terminal according to claim 2, wherein a shape of the parasitic unit is symmetrical meander lines.

16. The wireless terminal according to claim 3, wherein a shape of the parasitic unit is symmetrical meander lines.

17. The wireless terminal according to claim 4, wherein a shape of the parasitic unit is symmetrical meander lines.

18. The wireless terminal according to claim 2, wherein a material of the parasitic unit is metal.

19. The wireless terminal according to claim 3, wherein a material of the parasitic unit is metal.

20. The wireless terminal according to claim 4, wherein a material of the parasitic unit is metal.
